(19) United States
(12) Patent Application Publication
(10) Pub. No.: US 2005/0144792 A1
(43) Pub. Date: Jul. 7, 2005

(54) In-line sanding paddle with multiple extensions having certain tensile strengths

(75) Inventor: Jon Ritter, Cazadero, CA (US)

Correspondence Address: Mr. Jon S. Ritter, 17710 Dei Rd., Cazadero, CA, 95421, US

(73) Assignee: The Shire Corporation, Cazadero, CA (US)

(21) Appl. No.: 10/931,277

(22) Filed: Aug. 31, 2004

Related U.S. Application Data
(60) Provisional application No. 60/481,864, filed on Jan. 6, 2004.

(30) Foreign Application Priority Data
Mar. 29, 2004 (WO) PCT/US04/09432

(51) Int. Cl. B27B 19/14

(52) U.S. Cl. 30/392

(57) ABSTRACT

A simple attachment for a reciprocating tool that will effectuate the ability to do a flush cut in an inexpensive and simple manner which is neither too rigid, nor not rigid enough. This is effectuated by providing an insert, which fits into the reciprocating tool in the same fashion as a regular blade. The present invention then offsets the placement of a blade, sander, file, or other tool by as many inches as wished by the user. The blade, sander, file, or other tool is held rigid through the use of a 45 degree bracket spanning the distance from the original plane to the offset plane, or via a single or compound trapezoid design.

Priority is hereby claimed to U.S. patent application No. 60/481,864 filed on Jan. 6, 2004, as well as PCT /US04/09432 Mar. 30, 2004

### FIELD OF THE INVENTION

The present invention relates to an attachment for reciprocating tools, such as reciprocating saws. More particularly, the present is an offset attachment that permits a reciprocating tool to be fit with a variety of blades, sanders, and the like to attack a point from an offset angle.

### BACKGROUND OF THE INVENTION

Conventional reciprocating tools allow the user to attack a point straight on, or in other words, in a direct line from the tip of the reciprocating tool to the point. While a typical blade can be affixed in the center of the reciprocating tool, the body of the reciprocating tool oftentimes interferes with the surfaces around a point of attack.

For example, if a user wants to use a reciprocating tool to cut a two-inch by two-inch section in a dry wall area so that the two inch by two inch section is adjacent to a floor, the user cannot easily do so with a reciprocating tool. Because the saw blade extends out of the center front of the reciprocating tool, and the reciprocating tool has a bulky mass, the user can only make such a cut into the drywall at an angle away from ninety degrees. The best way to cut into the drywall is to maintain the saw blade perpendicular to the dry walk; however, because the reciprocating tool must remain above the floor, the user must approach the drywall so that the point of attack varies from ninety degrees from the drywall. Varying from a perpendicular point of attack, the user's cut is less reliable, less controlled, and encroaches into the drywall unevenly.

Restated, the problem is that the user cannot possibly position the reciprocating tool perpendicular to the drywall because the housing of the reciprocating tool must remain above the floor. There is a need for a device that allows reciprocating tool attachments perpendicular access to spaces wherein the mass of the reciprocating tool interferes with the normal point of attack.

In the past, users have attempted to create attachments capable of making cuts near an object while maintaining a perpendicular point of attack; however, such attachments have been either not rigid enough in order to effectuate a straight cut (that is, the saw attachments bend under the pressure of the saw attachments entering the drywall), have been too rigid thereby preventing the user from completing the cut all the way into a corner (that is, the saw attachments cannot be adjusted or interchanged as access to points of attack vary), or have been so complicated that they would break—and when broken, would be very expensive to fix. Thus, there is a need for a requisitely rigid offset attachment for a reciprocating tool that can be adjusted or interchanged easily that is not so complicated that the cost is prohibitive should it become damaged.

U.S. Pat. No. 3,028,890 issued on Apr. 10, 1962, to G. E. Atkinson, et al. describes a power saw which accepts a blade in both the center position and offset on the edge of the blade holders. Atkinson's blade holder is inferior to the present invention as Atkinson's blade holder can only adjust to various positions in line with the power saw; it is ill suited to make a cut in a wall at the point where the wall touches the floor because there is very little room to maneuver the body of the power saw. Further, Atkinson's blade holder does not offer any extension of the blade forward, so that the power saw can remain a greater distance from the cut while cutting.

U.S. Pat. No. 3,260,290 issued on Jul. 12, 1966, to R. Happe , et al. describes a power saw attachment, which accepts a blade for an offset position. However, Happe's device uses a guide rod, which shortens the cut of the blade and does not allow the blade to be as flexible as desired. Further, Happe's device does not allow for different and varied blade placements and offsets.

U.S. Pat. No. 4,553,306 issued on Nov. 19, 1985 to Mineck describes a reciprocating offset blade. Although Mineck's offset blade adapter does allow for the blade to be placed in more then one position, one of which is that of the flush cut, Mineck's adapter does so through a complicated device that, once broken, is expensive to replace. Further, Mineck's adapter does not allow for different and varied blade placements and offsets, and does not extend the distance between the blade and the reciprocating tool.

Thus, there is a need for an offset tool adapter for a reciprocating tool capable of distancing offset tool attachments from the offset tool itself (i.e. adding inches onto the length of the offset tool attachment). Further, there is a need for an offset tool adapter that allows various positioning so that the angle of attack to make a cut, etc. can be altered. Also, there is a need for an offset tool adapter that allows for quick interchangeability so that various offset tool attachments can be employed in short amount of time.

### SUMMARY OF THE INVENTION

The present invention is an attachment for reciprocating tools that allows blades, sanders, or any other device associated with a reciprocating tool to be quickly interchanged. The present invention has spaces common devices for reciprocating tools in different but parallel plane to the plane of the reciprocating tool. Thus, the user can access areas typically unreachable because with the present invention, the user can hold the reciprocating tool's body in a different plane than the device attached to the reciprocating tool. The present invention preferably has a 45 degree angle shift between the plane of the reciprocating tool and the plane of the device attached to the reciprocating tool. The angle provides a good blend of offset distance, structural integrity, and extension of the device ahead of the reciprocating tool.

Alternative embodiments of the present invention provide for rotation at the point where the reciprocating tool's body attaches to holder for a device attached to a reciprocating tool, such that the holder for the device attached to the reciprocating tool rotates for ease of use in accessing work areas. Additional embodiments of the present invention provide for rotation at the point where the device attached to a reciprocating tool attaches to blades, sanders, or any other device associated with a reciprocating tool—such that the device attached to a reciprocating tool rotates for ease of use in accessing work areas. Further embodiments of the present invention provide means to extend the reach of blade attachment with stability and strength, additional sanding paddles and a multi tool attachment. The extension may be anywhere from 2 inches to 10 feet, however the preferred length is 2 inches to 2 feet. The sanding paddles, of all shapes and sizes, are preferably made of memory plastic and that has the capability to attach sandpaper to at least one side via one of many conventional fastening means, such as glue, hook and loop or adhesive tape.

### BRIEF DESCRIPTION OF THE DRAWINGS

FIG. 1 is a right side view of a first embodiment of the present invention.

FIG. 2 is an environmental view a second embodiment of the present invention

FIG. 3 is a side view of a third embodiment of the present invention.

FIG. 4 is a side view of a fourth embodiment of the present invention.

FIG. 5 is a cross section view of a fifth embodiment of the present invention.

FIG. 6 is a cross section view of a sixth embodiment of the present invention.

FIG. 7 is a cross section view of a seventh embodiment of the present invention.

FIG. 8 is a side view of the seventh embodiment

FIG. 9 is a side view of the multi tool attachment

FIG. 10 is a side view of the extension

FIG. 11 is an environmental view of the sanding paddle attachment attached to the extension.

FIG. 12 is an environmental view of the sanding paddle.

FIG. 13 is an environmental view of the adjustable multiple attachment system.

### DESCRIPTION OF THE PREFERRED EMBODIMENT(S)

As seen in the attached drawings, the present invention is designed to be used with any power driven saw (10) having a reciprocating drive member (20). The present invention has an offset adapter (30) made up of a first, second, and third metal planes (40, 50, 60), two angle braces (70, 80), a conventional set screw (90), preferably a conventional screw that can be tightened or loosened by user with hands, and a set screw receiving member (100).

The first straight metal plane (40) is designed to insert into the reciprocating drive member (20) and has the standard hole (25) used for locking any reciprocating saw blade into a reciprocating drive member (20). The second straight metal plane (50) is disposed anywhere from 90-degrees to 45 degrees from the first metal plane (40), and the second straight metal plane (50) is correspondingly attached to the third metal plane (60) anywhere from 90-degrees to 45 degrees from the third metal plane (60).

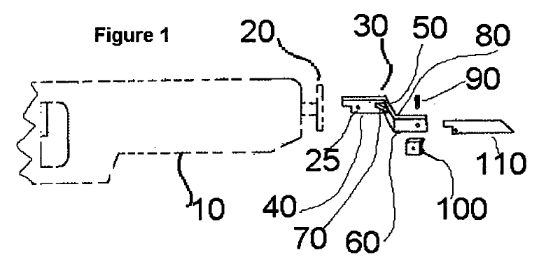

The first metal plane (40) and third metal plane (60) are, at all times, parallel with each other. In the embodiment shown in FIG. 1, the first, second, and third metal planes (40, 50, 60) are shown with a 90-degree connection. Between the first, second, and third metal planes (40, 50, 60) are angle braces (70, 80). These braces are designed to support the offset adapter (30) while still allowing the device to be flexible enough to access angles, which are not normally accessible, by the adapter (30). For example, if the user desires to use standard blade (110) to cut a hole in a wall, but the desired angle of approach to the wall cannot be achieved because of the relatively parallel arrangement of standard blade (110) and power driven saw (10), then angle braces (70, 80) flex to allow the user to engage the wall. In such case, once the user has inserted standard bland (110) into the wall, the user can pull or push the power driven saw (10) so that the angle braces (70,80) flex—that is the angle braces extend and compress—to create the desired angle of approach.

The third metal plane (60) is designed to accept a standard blade (110) in the same fashion as that of the reciprocating drive member (20) by using a conventional set screw (90) and a set screw-receiving member (100). Set screw receiving member (100) is a U-shaped piece of metal that sandwiches standard blade (110) when standard blade (110) is held adjacent to third metal plane (60).

Alternative embodiments of the invention are many and varied. The first, second, and third metal planes (40, 50, 60), may be lengthened or shortened depending on the type of power driven saw (10) employed and depending on the additional offset length or reach desired. Further the angles between the first, second, and third metal planes (40, 50, 60) may also be changed in order to allow the user to make cuts at numerous angles. As the adapter (30) is inexpensive to manufacture, and is quite simple in design, many different lengths of first, second, and third metal planes (40, 50, 60) may be provided in a box in much the same fashion as drill bits are conventionally sold.

It should be noted that no matter the format of the adapter (30), it is always able to fit into a conventional power driven saw (10). As aforementioned, in FIG. 1, the standard hole (25) identical to the conventional hole used for locking any reciprocating saw blade into a reciprocating drive member (20) is shown.

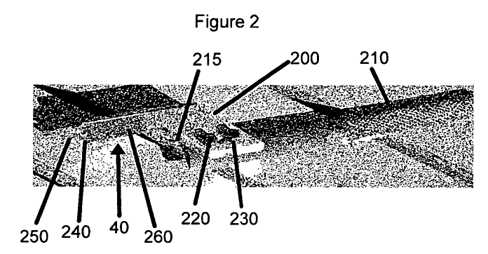

Another embodiment of the present invention has second metal plane (50) and angle braces (70, 80) merged as one piece with greater girth, so that merged together, they appear as a trapezoid (200), as shown in FIG. 2. The trapezoid (200) provides even greater structural integrity than second metal plane (50) and angle braces (70, 80), if no flexing, as aforementioned, is desired. Optionally, trapezoid (200) could be made of a flexible material so that trapezoid (200) bends and flexes similar to second metal plane (50) and angle braces (70, 80). Trapezoid (200) is conventionally bolted to first metal plane (40).

Another embodiment of the present invention has third metal plane (60) deleted because trapezoid (200) is specially modified to communicate with file (210). This embodiment allows the adapter (30) to hold other implements such as file (210), sanders, or any other device that can fit in slot (215) and be conventionally bolted via first bolt (220) and second bolt (230). Second bolt (230) can be conventionally spring loaded.

An additional embodiment, as shown in FIG. 2, has a curved collar (240) that mates with the internal shape of reciprocating drive member (20) to form a curved fit that better holds first metal plane (40) in place. Preferably, curved collar (240) is a boundary between first section (250) of first metal plane (40) and second section (260) of first metal plane (40), such that first section (250) is narrower than second section (260).

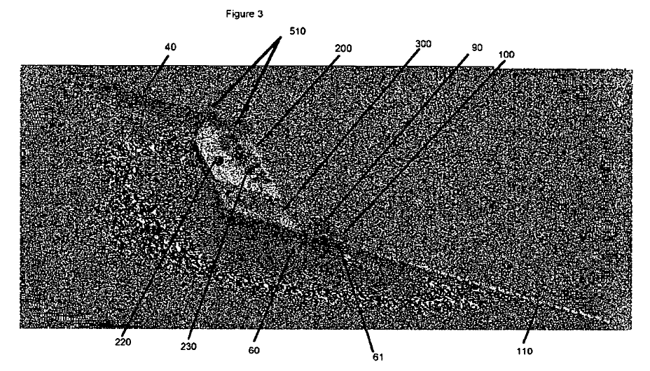

As shown in FIG. 3, another embodiment of the present invention has blade trapezoid (300) that is an extension mounted below and partially within trapezoid (200). This embodiment allows the adapter (30) to hold a standard blade (110) when trapezoid (200) is employed in place of second metal plane (50). Blade trapezoid (300) can fit in slot (215)—shown in FIG. 2—and be conventionally bolted within and to trapezoid (200) via first bolt (220) and second bolt (230). For quick removal, second bolt (230) can be spring-loaded. Blade trapezoid (300) communicates with third metal plane (60), in this embodiment, such that conventional set screw (90) and a set screw receiving member (100) sandwich standard blade (110) when standard blade (110) is held adjacent to third metal plane (60). Trapezoid (200) is held to first metal plane (40) via top fasteners (510). Third metal plane (60) has a bevel (61) on its lower front end, to provide for greater clearances near surfaces.

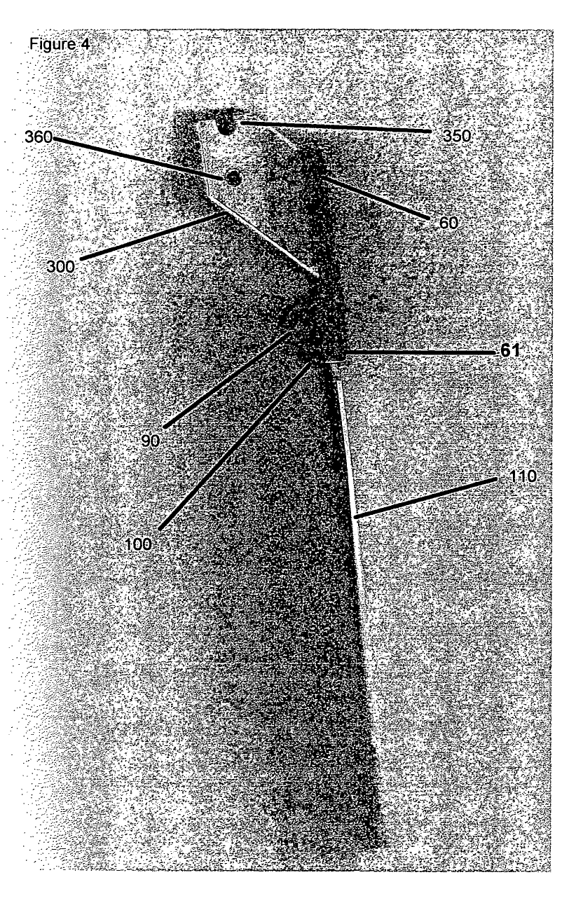

In another embodiment, second bolt (230) can be turned by the user's fingers to move through trapezoid (200) and contact blade trapezoid (300). This is significant because blade trapezoid (300)—as shown in FIG. 4—has first receiving aperture (350) that is merely an arc for receiving first bolt (220), whereas second receiving aperture (360) is actually a hole for receiving second bolt (230). The user can simply slide first receiving aperture (350) on and off first bolt (220) upon engaging and disengaging second receiving aperture (360) with second bolt (230), allowing for a “quick change” operation. Because of this quick change feature, blade trapezoid (300) can be fixed to other common tools such as sanders, files, and the like, in place of standard blade (110) to allow the user to quick change a variety of common tools and affix them to trapezoid (200).

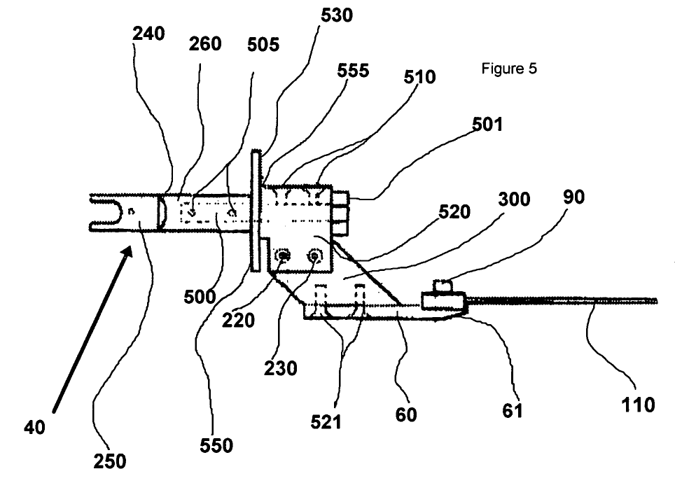

A further alternative embodiment of the present invention allows one or two rotation points in relation to the conventional power driven saw (10). As shown in FIG. 5, this embodiment has a curved collar (240), as in FIG. 2, mating with the internal shape of a conventional reciprocating drive member to form a curved fit that better holds first metal plane (40) in place. The embodiment shown in FIG. 5 also has curved collar (240) as a boundary between first section (250) of first metal plane (40) and second section (260) of first metal plane (40), such that first section (250) is narrower than second section (260)—this is just as in FIG. 2. In the embodiment of FIG. 5, though, first metal plane (40) receives first rod (500) and holds first rod (500) via side fasteners (505), and first rod (500) attaches via top fasteners (510) to be held within block region (520). Trapezoid (200) of FIGS. 2 and 4 is replaced by block region (520) in this embodiment to allow a first point of rotation to occur as further explained below.

Within block region (520), first rod (500) serves as an axis of rotation. Dial (530) is preferably a numeric dial through which first rod (500) passes and to which first rod (500) is fixed, and dial (530) is sandwiched between second section (260) of first metal plane (40) and block region (520). Dial (530) is turned on the threaded end (501) of first rod (500), and when dial (530) has been completed turned to pass over the entire threaded end (501) of first rod (500), dial (530) is fixedly attached to first rod (500) and remains stationary. Alternatively, dial (530) can be simply molded or otherwise conventionally attached to first rod (500).

Lock nut (540) applies pressure to block region (520) because lock nut (540) is tightened on the end of first rod (500). Block region (520) is prevented from rotating about first rod (500) because lock nut (540) applies pressure to fixedly hold it and prevent rotation. While top fasteners (510) do hold block region (520) on first rod (500) to prevent rotation, they are not required because of the pressure applied by lock nut (540).

Optionally, dial (530) has first teeth (550) that communicate with second teeth (555) of block region (520). Use of first teeth (550) and second teeth (555) provides further prevention against bock region (520) moving in relation to first rod (500).

To rotate the present invention, side fasteners (505) are not loosened and/or removed from second section (260) of first metal plane (40)—side fasteners remain against first rod (500) so that first rod (500) does not rotate. The user loosens lock nut (540) from the end of first rod (500), and if top fasteners (510) are being employed, they too are loosened. With lock nut (540) and any top fasteners (510) so loosened, block region (520) is free to rotate about first rod (500). The user rotates block region (520) along with first rod (500), but does so after first teeth (550) are separated from second teeth (560) if first teeth (550) and second teeth (560) are being employed. The separation is possible once lock nut (540) has been loosened so that block region (520) can not only rotate, but move away from dial (530) along first rod (500).

Once block region (520) has been rotated to the position desired by the user, first teeth (550) and second teeth (560), if present, are fitted together as block region (520) is moved along first rod (500) flush against dial (530), and lock nut (540) is tightened. Top fasteners (510), if present, are reattached to block region (520) to hold block region (520) on first rod (500) to prevent rotation of block region (520). Note that bottom fasteners (521) are shown linking blade trapezoid (300) to third metal plane (60).

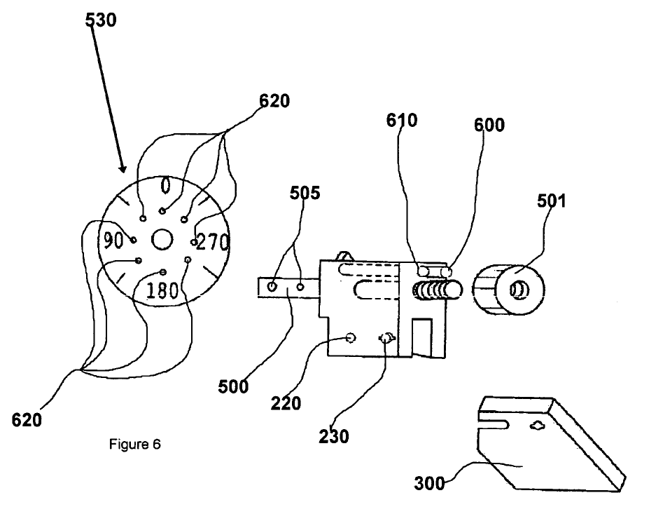

As shown in FIG. 6, another embodiment of the present invention also has dial (530) and block region (520); however, in this embodiment, top fasteners (510)—shown in FIG. 5—are absent and replaced with location pin (600). Pin aperture (610) receives location pin (600), and location pin (600) slides back and forth within pin aperture (610) as lock nut (540) is tightened upon first rod (500).

In operation, when lock nut (540) pushes location pin (600) through pin aperture (610), location pin (600) slides through one of dial apertures (620) to prevent block region (520) from rotating about first rod (500). When lock nut (540) is loosened upon first rod (500), location pin (600) can be pushed with the user's finger so that location pin (600) moves out of one of dial aperture (620) so that block region (520) can rotate about first rod (500). The placement of location pin (600) through pin aperture (610) depends upon how much or how little block region (520) is rotated about first rod (500). Conventional indicia on dial (530) can show the location pin (600) positioning along the dial (530), and thus, the positioning of block region (520) because block region (520) rotates with location pin (600).

In FIG. 6 the first bolt (220) and second bolt (230) fit into first bolt aperture (221) and second bolt aperture (231). The second bolt (230), if spring loaded, fits into second bolt aperture (231), which conventionally receives second bolt (230).

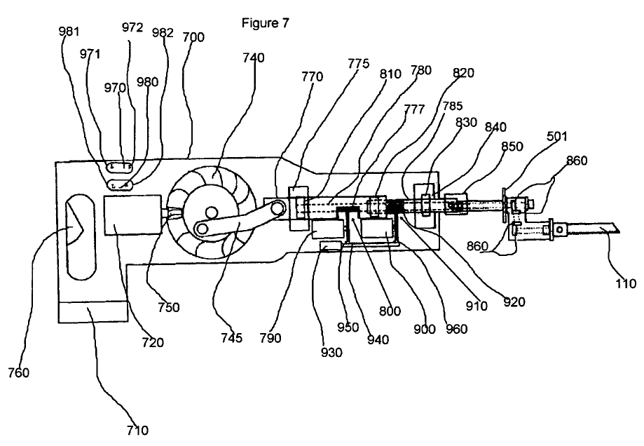

FIG. 7 shows a motorized embodiment of the present invention. In this embodiment, power driven saw (10) is not employed; rather, a rotating power saw (700) is employed that is specially designed as part of the present invention. Rotating power saw (700) is attached to a conventional battery pack (710). A first motor (720) operates a first drive wheel (740) via a conventional first worm type gear (750). A conventional trigger switch (760) conventionally communicates with first motor (720) to allow the user to turn first motor (720) on and off. First drive wheel (740) repeatedly moves arm (760) away from first drive wheel (740) and toward first drive wheel (740) as first drive wheel (740) rotates because first drive wheel (740) is conventionally attached to arm (760). Central block (770) repeatedly moves in concert with arm (760) because central block (770) and arm (760) are conventionally attached to one another. A first mounting bracket (775) holds central block (770) in place while allowing for desired movement towards and away from first drive wheel (740).

A first drive line (780) is, at one end, positioned internal of central block (770). Second motor (790) rotates first drive line (780) via a conventional first spine gear assembly (800). The outer surface of first drive line (780) has conventional first ridges (777) to communicate with first spine gear assembly (800). First drive line (780) is, at its central portion, positioned within second drive line (785) right before first drive line (780) exists central block (770). First bearing (810) allows first drive line (780) to rotate within central block (770), while second bearing (820) allows first drive line (780) to rotate within both central block (770) and second drive line (785). Second drive line (785) continues halfway into quick change chuck (850). Third bearing (830) allows first drive line (780) to rotate within second drive line (785). Second mounting bracket (840) holds third bearing (830) in place. First drive line (780) continues into quick change chuck (850). At the end of first drive line (780) is a female receptacle (781). Female receptacle (781) is utilized to receive male member (782) of third drive line (783).

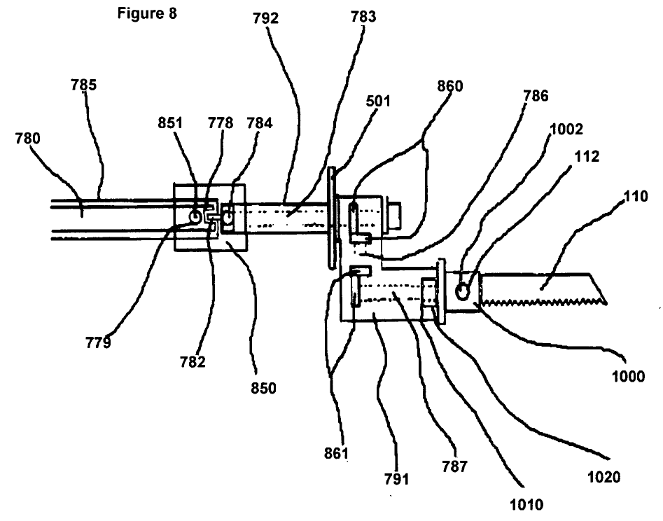

As shown in FIG. 8 through quick change chuck (850), third drive line (783) and second drive line (785) are first chuck aperture (851), third drive line aperture (784) and second drive line aperture (779) to allow a pin to be inserted to secure all pieces together. Third drive line (783) then continues through dial (501) and into housing (791). Housing (791) in previous embodiments was comprised of 3 different pieces, trapezoid (200), blade trapezoid (300) and block region (520). At the end of third drive line is connected to fourth drive line (786) via worm gears (860). Forth drive line (786) is connected to fifth drive line (787) via worm gears (861). Fifth drive line (787) is then connected to blade chuck (1000) via male, female connecters. At the end of fifth drive line (787) is female connector (1010). Female connector (1010) receives male connector (1020), which is on the insertion end of standard blade (110). Blade chuck (1000) and standard blade (110) have second chuck aperture (1002) and blade aperture (112) to allow a pin to be inserted to secure standard blade (110).

Second drive line (785) is, at one end, positioned internal of central block (770). Third motor (900) rotates second drive line (785) via a conventional second spine gear assembly (910). The outer surface of second drive line (785) has conventional second ridges (920) to communicate with second spine gear assembly (910). Second drive line (785) is, at its central portion, positioned within third bearing (830).

Rotation of first drive line (780) and second drive line (785) is prevented via manual lever (930). If the user turns manual lever (930), lever cylinder (940) turns as well because it is fixed to manual lever (930). When lever cylinder (940) turns, first gear interrupter (950) communicates with first spine gear assembly (800). Similarly, when lever cylinder (940) turns, second gear interrupter (960) communicates with second spine gear assembly (910). Thus, when the user has rotated first drive line (780) and second drive line (785) as desired, the user can turn lever cylinder (940) to prevent any movement of first drive line (780) and second drive line (785). To cause first drive line (780) and second drive line (785) to rotate, the user needs to press first switch (970) or second switch (980), respectively. First switch (970) conventionally communicates with second motor (790), which in turn rotates first drive line (780) as aforementioned. Second switch (980) conventionally communicates with third motor (900), which in turn rotates second drive line (785) as aforementioned. First switch (970) and second switch (980) both have an option of polarity to control the clock wise or counter clockwise direction of drive wheel (740). First switch (970) has first left switch (971) and first right switch (972); selecting one of these will cause second motor (790) to respond accordingly. Second switch (980) has second left switch (981) and second right switch (982); selecting one of these will cause third motor (900) to respond accordingly.

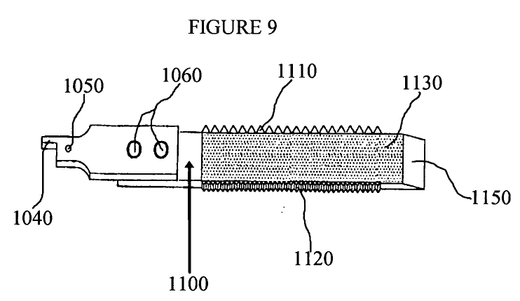

In place of standard blade (110) a “multi-tool” attachment (1100), as shown in FIG. 9, can be attached. Multi tool attachment (1100) has, on first edge (1110), a wood saw, on second edge (1120), a metal saw, on first side (1130), a wood rasp, on second side (1140), a metal rasp/file (not shown) and on the tip (1150), a chisel. Additionally a conventional chisel blade can be attached, and as the conventional chisel comes in many different shapes and sizes so will the conventional chisel blade attachment.

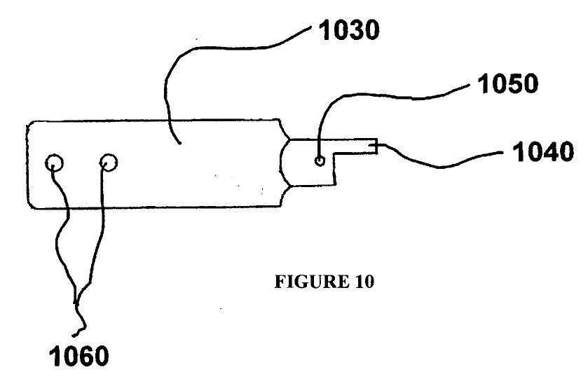

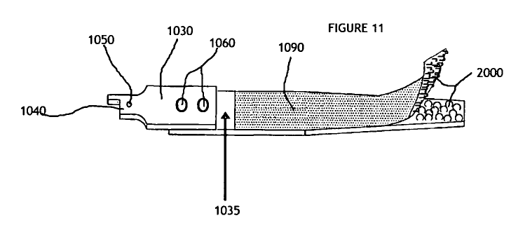

As shown in FIG. 10, an alternative embodiment of the present invention has an extension (1030) that connects the power driven saw (10) to the reciprocating saw blade. The extension (1030) can accommodate all conventional reciprocating saw blades, and is designed to allow the user to use the reciprocating to cut an area that is away from their reach. While the extension (1030) can potentially be 10 feet, stability is an important factor in determining the length of the extension (1030). While the extension (1030) can be longer, the preferred length of the extension (1030) is anywhere from 12-24 inches. The extension (1030)'s insertion point (1040) contains a drill hole (1050) that attaches to the power saw at third metal plane (60) of the offset adapter (30) (not shown in FIG. 10). The extension (1030) further contains two drill holes (1060) that attaches to the reciprocating drive member (20) of the blade. The extension (1030) can also attach to a flat paddle (1035), made of memory plastic, with the capability to interchange abrasive surfaces (such as sandpaper(1090)) utilizing a hook and loop type fastener (2000), as a method of attachment to the extension (1030) (shown in FIG. 11).

As previously stated, it is important that the extension (1030) maintains stability in order to provide adequate support for the standard blade (110), multi tool attachment (1100), conventional chisel or rasp and the sanding paddle (1035). It is equally important for the extension (1030) to maintain durability and to provide reasonable flex while in action. It has been observed that most steel alloys conventional in the art are not durable, stable, or flexible enough to be well suited for an extension (1030) of this caliber. Observation has shown that when a heavier attachment such as the multi tool attachment (1100) conventional rasp or chisel is used in conjunction with extension (1030), when made of the weaker steal, the inertia of the heavier attachment pulls on extension (1030) and in turn snaps extension (1030) rendering it unserviceable. For that reason, it is preferred that the steel be durable and stable enough to withstand the reciprocating action of the power driven saw (10), while maintaining the flex that will allow access to angles which are not normally accessible by an offset adapter (30).

While each one requirement is important, choosing the right steel alloy is a balancing act. For example, steel alloys of a 1095 grade (with 95 carbon content) might be inexpensive, however they do not provide the durability that works best with the present invention. On the other hand, H13 steel is extremely hard, yet is so brittle that it lacks the stability required to operate the present invention. A steel alloy that provides enough durability and stability, while maintaining flexibility that will not bent too easily is required in order for the extension to operate in furtherance of the principles of the present invention, is necessary. Three metals have been conceived in the present invention: S7 (at the recommended hardness of 54 Rockwell), Vanadis #4, and particularly Flexor TM (at the recommended hardness of 48 Rockwell). The steel alloys are oil quenched in order to improve hardness of the alloys. While these alloys work best, the present invention is not limited to the aforementioned steel alloys, and can employ any steel alloy in furtherance of the principles of the present invention.

The entire extension (1030) can be, and is preferred to be, the same alloy throughout. The portion of the extension (1030) at the insertion point (1040) requires a durable and stable metal. However, the rest of the extension (1030) may be a different, cheaper metal that is still durable, stable and flexible, yet not as expensive. While steel alloys of a 1095 grade are not appropriate at the insertion point (1040), the remainder of the extension (1030) may constitute the 1095 grade alloy. However, it may be preferable that the entire extension (1030) maintains the same steel alloy throughout.

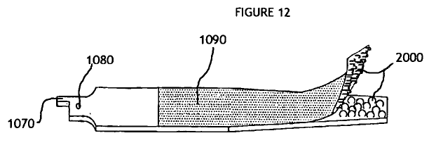

As shown in FIG. 12, an alternative embodiment of the present invention has an in-line or off-set sanding paddle (1035) that attaches to the present invention. The insertion point (1070) of the sanding paddle (1035) has a drill hole (1080) that attaches to either the reciprocating drive member (20) (which causes the paddle to be in-line) or the third metal plane (60) of the offset adaptor (30) (which causes the paddle to be offset). The sanding paddle (1035) can also be attached to the above mentioned extension (1030). The sanding paddle (1035) can also be molded around the key, such that it is permanently affixed to the insertion key (1070). The sanding paddle (1035) contains conventional sanding paper on a first side of the paddle (1090). A second, opposite side (2010) of the sanding paddle (1035) may have steel or any other type of metal in furtherance of the principles of the present invention. The second side (2010) of the sanding paddle (1035) may also be a flexible plastic or rubber material with memory flexes such that the sanding paddle (1035) can flex and form to a particular area, and then return to its manufactured shape. The conventional sanding paper can be affixed to the first side (1090) of the sanding paddle (1035) via glue, clamps, or it can be attached via a hook and loop type fastener (2000), or any type of conventional attachment in furtherance of the principles of the present invention. The preferred embodiment of this hook and loop type fastener (2000) is such that the loop portion is embedded in the plastic portion of the sanding paddle (1035), such that there is no deterioration of the conventional sanding paper involved in affixing the hook and loop type fastener (2000). In an alternate embodiment first and second sides (1090 and 2010) of the sanding paddle (1035) are covered in one strip of conventional sanding paper by being attached to the first side (1090) then folding over the tip and attaching to the second side (2010). Other alternate embodiments would include different shaped sanding paddles (1035) such as a circle to cover more surface area and triangles in different positions to reach different corners, however many other shapes and sizes can be applied.

Another embodiment for the sanding paddle (1035) is a plastic sleeve capable of fitting onto the existing attachment (i.e. standard blade (110) or conventional rasp or chisel) and snapping into place for quick use of both attachments.

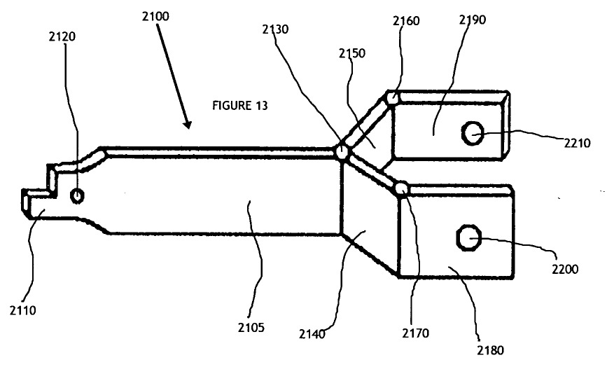

To employ the use of more than one of any reciprocating saw attachment (i.e. standard blade (110), conventional rasp or chisel, or the multi tool attachment (1100)), an adjustable multiple attachment system (2100) is used. As shown in FIG. 13, an adjustable multiple attachment system (2100) allows at least two standard blades (110), two multi tool attachments (1100), or two sanding paddles (1035) to be attached to one reciprocating saw to be used simultaneously. The insertion point (2110) is the same as all attachments with a drill hole (2120). The multiple attachment system (2100) has base member (2105) extends 2″-3″ until it forks at first adjustable hinge (2130). Adjustable hinge (2130) allows first adjusting arm (2140) and second adjusting arm (2150) to adjust the width between the two standard blade (110) or sanding paddle (1035) attachments. On the opposite ends of first and second adjusting arms (2140 and 2150) are second adjustable hinge (2160) and third adjustable hinge (2170). Second and third adjustable hinges (2160 and 2170) allow third adjusting arm (2180) and fourth adjusting arm (2190) to adjust the Z-axis angle of the blade or paddle attachments. The blade or paddle attachments clamp onto the ends of third and fourth adjusting arms (2180 and 2190) at first attachment fastener (2200) and second attachment fastener (2210). Each of the adjustable hinges (2130,2160 and 2170) and the attachment fasteners (2200 and 2210) are all controllable by a conventional thumb screw.

The following is a list of tools that can be attached in place of standard blade (110):
Rod Saw Blade
Coping Saw Blade
Hacksaw Blade
cross cut saw
rip saw
jig saw
back saw
compass saw
panel saw
flooring saw
tenon saw
pad saw
bow saw and bow connection
coping saw
log saw
log saw double sided for connection to two sawzalls
spiral cut saw
scissor pull cutter with brace
key hole saw
drywall saw
Rasps & Files—all metal and wood types
Buffers & Sanders—all short and long handle types

Some of the aforementioned tools, which can be used in place of standard blade (110), may require conventional adaptors.

The present invention is not limited to the embodiments aforementioned, but encompasses any and all embodiments within the scope of the following claims.

1. An adapter for a reciprocating drive unit, comprising:
three plane members;
two angle braces, in communication with said plane members;
a set screw receiving member, in communication with one of said plane members; and
a set screw, in communication with said set screw receiving member.

2. An adapter for a reciprocating drive unit, comprising:
a first plane member;
a second plane member, in communication with said first plane member at a 45 degree angle; and
a means for attaching a conventional tool to said second plane member.

3. An adapter for a reciprocating drive unit, comprising:
a first plane member;
a second plane member, in communication with said first plane member at a 45 degree angle;
a third planar member, fitting inside and communicating with said second planar member; and
a means for attaching a conventional tool to said third planar member.

4. An adapter for a reciprocating drive unit, comprising:
a rod;
a block region, in communication said rod;
a first planar member, in communication with said block region at a 45 degree angle; and
a second planar member, in communication with said first planar member;
wherein said block region rotates around said rod.

5. The device of claim 4, further comprising a dial in communication with said rod.

6. The device of claim 5, further comprising a pin in communication with said block region and said dial.

7. An adapter for a reciprocating drive unit, comprising:
a chuck;
a first drive line housing, in communication with said chuck;
a drive line, disposed within said first dive line housing;
an L-shaped member, in communication with said drive line;
a conventional tool, in communication with said L-shaped member and said drive line.

8. A reciprocating drive unit, comprising:
a housing;
a first drive line, exiting and entering said housing;
a second drive line, rotating within and extending outside of said housing; and
a third drive line, rotating within said second drive line.

9. An extension for a reciprocating drive unit, comprising:
a base member;
a insertion key, in communication with said base member;
at least one drill hole on said base member; and
a drill hole on said insertion key.

10. The device of claim 9, wherein said base member is made of a metal between 1095 and 4140.

11. The device of claim 9, wherein said insertion is made of a metal of a grade between 1095 and 4140.

12. The device of claim 10, wherein said base member and said insertion key is made of a metal of a grade between 1095 and 4140.

13. A sanding paddle attachment for a reciprocating saw, comprising: an insertion key;
a paddle in communication with said insertion key;
a fastener in communication with said paddle; and
sandpaper.

14. The device of claim 13, wherein said paddle can be many different shapes and sizes.

15. The device of claim 13, wherein said fastener can be anyone of the following; hook and loop, glue, clamps or any other conventional adhesive.

16. The device of claim 13, wherein said sandpaper is any grad of coarseness.

17. A multi tool attachment comprising;
an insertion point;
a base member in communication with said insertion point;
an first hinge in communication with said base member;
a first arm in communication with said first hinge;
a second arm in communication with said first hinge;
a second hinge in communication with said first arm;
a third hinge in communication with said second arm;
a third arm in communication with said second hinge;
a fourth arm in communication with said third hinge;
a first fastener in communication with said third arm; and
a second fastener in communication with said fourth arm.

18. The device of claim 17, wherein said first hinge in adjustable.

19. The device of claim 17, wherein said second hinge is adjustable.

20. The device of claim 17, wherein said third hinge is adjustable.

21. The device of claim 17, wherein said first hinge is adjustable using a conventional thumb screw.

22. The device of claim 17, wherein said second hinge is adjustable using a conventional thumb screw.

23. The device of claim 17, wherein said third hinge is adjustable using a conventional thumb screw.

24. The device of claim 17, wherein said first arm is adjustable.

25. The device of claim 17, wherein said second arm is adjustable.

26. The device of claim 17, wherein said third arm is adjustable.

27. The device of claim 17, wherein said fourth arm is adjustable.

28. The device of claim 17, wherein said first arm adjusts the space between said attachments.

29. The device of claim 17, wherein said second arm adjusts the space between said attachments.

30. The device of claim 17, wherein said third arm adjusts the angle of said attachments.

31. The device of claim 17, wherein said fourth arm adjusts the angle of said attachments.

32. The device of claim 17, wherein said fastener is a conventional thumb screw.
